(19) United States
(12) Patent Application Publication
(10) Pub. No.: US 2008/0179869 A1
(43) Pub. Date: Jul. 31, 2008

(54) Chassis structure of a people carrying vehicle

(76) Inventor: Arthur Wang, Gangshan Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/700,160

(22) Filed: Jan. 31, 2007

(51) Int. Cl. B62D 21/10

(52) U.S. Cl. 280/781

(57) ABSTRACT

A vehicle chassis includes a front chassis with a rear inverted-U-shaped member, a rear chassis, and a locking mechanism on the rear chassis for locking the inverted-U-shaped member to secure the front and the rear chassises together; the locking mechanism includes a housing with a gap, a pivotal locking piece next to one side of the gap, and a pivotal detaining piece next to other side of the gap; the locking piece will be automatically pivoted to a locking position to detain the inverted-U-shaped member when the inverted-U-shaped member is passed into the gap; the locking and the detaining pieces are subjected to first and second elastic return forces respectively; the first elastic return force biases the locking piece towards a non-locking position; the second elastic force biases the detaining piece such that the detaining piece will engage the locking piece when the inverted-U-shaped member is passed into the gap.

### BACKGROUND OF THE INVENTION

1. Field of the invention

The present invention relates to an improvement on a chassis of a people carrying vehicle, more particularly one, which includes a front chassis, and a rear chassis, and is structured in such a way that the front chassis and the rear chassis can be easily and rapidly secured together.

2. Brief Description of the Prior Art

Referring to FIG. 9, a currently existing electric walk-substituting cart (people carrying vehicle) includes a front chassis 91, a rear chassis 92, and a coupling structure 93. The front chassis 91 includes a rear transverse rod 911 at a rear end, an upright pipe 912 at the rear end, a large beam 914, and a rear curved rod 913 joined to both the upright pipe 912 and the large beam 914. The upright pipe 912 has a receiving hole 9121 on an upper end thereof. The rear chassis 92 includes a supporting rod 921, an assembling member 922 secured on a front side of the supporting rod 921, and a front transverse support part 923. The front transverse support part 923 has a locating hollow portion 924 on a front side thereof. The locating hollow portion 924 has a plate portion 9241, and several screw holes 9242 on the plate portion 9241. The coupling structure 93 is disposed on the assembling member 922, and includes a sleeve 931, a spring 932, and a locking rod 933; the locking rod 933 has an annular protrusion 934, and passes through the sleeve 931; the spring 932 is received in the sleeve 931, and comes into contact, at a lower end thereof, with the annular protrusion 934 of the locking rod 933 so as to bias the locking rod 933 downwards. In assembly, the rear transverse rod 911 of the front chassis 91 is received in the locating hollow portion 924 of the front transverse support part 923 of the rear chassis 92, and the upper end of the upright pipe 912 received in the assembling member 922 of the rear chassis 92, and the locking rod 933 passed into the receiving hole 9121 of the upright pipe 912. And, bolts 9243 are passed through the screw holes 9242, and tightly pressed against the rear transverse rod 911.

The front chassis and the rear chassis can be firmly joined together by means of the assembling member, the locating hollow portion, the upright pipe, the coupling structure, the rear transverse rod, and the bolts. However, such a walk-substituting cart has a disadvantage: in assembly, the locking rod of the coupling structure has to be lifted, the upper end of the upright pipe placed in the assembling member, and the receiving hole of the upright pipe faced with the locking rod in order for the locking rod to pass into the receiving hole. Therefore, it takes relatively much time to assemble the chassis, and there is room for improvement.

Therefore, it is a main object of the present invention to provide an improvement on a chassis of a people carrying vehicle to overcome the above-mentioned problem.

### SUMMARY OF THE INVENTION

A people carrying vehicle chassis according to an embodiment of the present invention includes a front chassis, a rear chassis, and a locking mechanism. The front chassis has an inverted-U-shaped member secured on a rear end thereof. The locking mechanism is fitted on the rear chassis for locking the inverted-U-shaped member to secure the front chassis and the rear chassis together. The locking mechanism includes a housing with a gap, a pivotal locking piece next to one side of the gap, and a pivotal detaining piece next to the other side of the gap. The locking piece will be pivoted to a locking position to detain the inverted-U-shaped member when the inverted-U-shaped member is passed into the gap to join the front chassis and the rear chassis together. The locking and the detaining pieces are subjected to first and second elastic return forces respectively; the first elastic return force biases the locking piece such that the locking piece is normally in a non-locking position; the second elastic return force biases the detaining piece such that the detaining piece will engage and fix the locking piece so as to make the locking piece fix the inverted-U-shaped member to the housing when the inverted-U-shaped member is passed into the gap.

### BRIEF DESCRIPTION OF THE DRAWINGS

The present invention will be better understood by referring to the accompanying drawings, wherein:

FIG. 1 is a partial view of the conventional cart, taken in assembly,

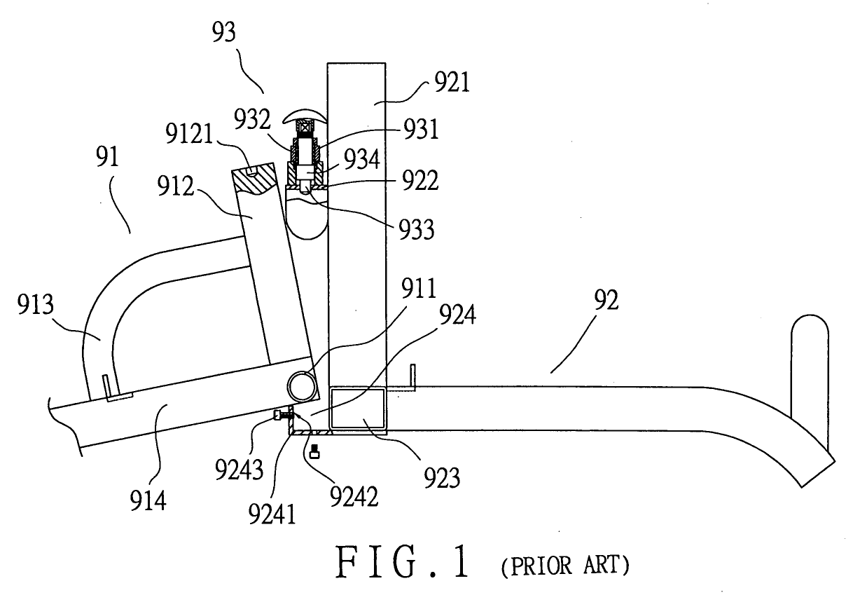

FIG. 2 is a partial view of the present invention, taken in assembly,

FIG. 3 is a partial view of the present invention, taken after assembly,

FIG. 4 is a side view of the present invention,

FIG. 5 is an exploded perspective view of the locking mechanism of the present invention,

FIG. 6 is a top view of the housing of the locking mechanism,

FIG. 7 is a perspective view of the locking mechanism,

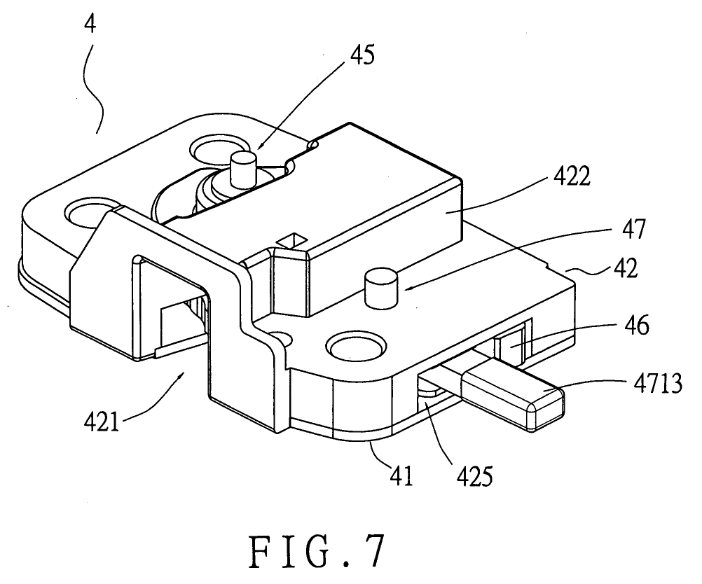

FIG. 8 is a horizontal sectional view of the locking mechanism, taken when the locking mechanism in a locking position, and

FIG. 9 is a horizontal sectional view of the locking mechanism, taken in an unlocking action.

### DETAILED DESCRIPTION OF THE PREFERRED EMBODIMENTS

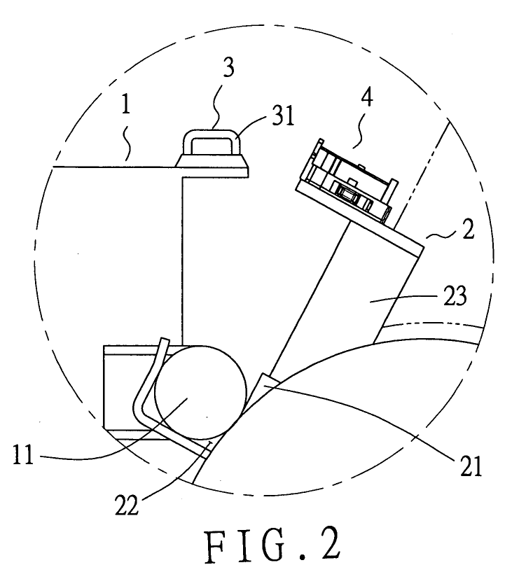

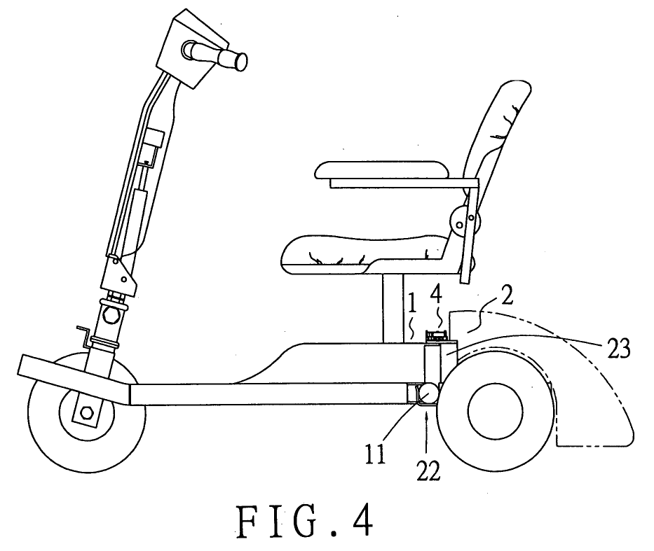

Referring to FIGS. 2 to 4, a preferred embodiment of a chassis of a people carrying vehicle of the present invention includes a front chassis 1, a rear chassis 2, and a locking mechanism 4. The people carrying vehicle can be an electric walk-substituting cart or an electric wheel chair.

The front chassis 1 includes a rear transverse rod 11. The rear chassis 2 includes a front transverse rod 21, a locating hollow portion 22 on a front side of the front transverse rod 21 for receiving the rear transverse rod 11 of the front chassis 1, and a supporting rod 23 sticking upwards from a middle portion of the front transverse rod 21.

Furthermore, the front chassis 1 has an inverted U shaped locking member 3 secured on a rear end thereof. The inverted U shaped locking member 3 includes a rear straight rod portion 31.

The locking mechanism 4 includes:

a bottom plate portion 41, the bottom plate part 41 has a trench shaped gap 411 extending from a middle of a front edge thereof towards a rear side; the bottom plate part 41 has lower left and lower right pivotal holes 412 and 413 on two sides of the trench shaped gap 411, and a detaining hole 414 next to the lower right pivotal hole 413;

a housing member 42 disposed over the bottom plate part 41, the housing member 42 has a gap 421 right above the trench shaped gap 411 of the bottom plate part 41; the housing member 42 has a hollow holding portion 422 to a right of the gap 421; the housing member 42 has a hollow confining portion 423 to the left of the gap 421, and an upper left pivotal hole 424 facing the lower left pivotal hole 412 of the bottom plate part 41; furthermore, the housing member 42 has a right hollow containing portion 425, and an upper right pivotal hole 426 facing the lower right pivotal hole 413 of the bottom plate part 41;

a first buffer block 43 disposed to a left of the gap 421 in the housing member 42;

a pivotal rod 44, the pivotal rod 44 is received in the hollow holding portion 422, and passed through a buffer block 441 at a front end, and next passed through an elastic element 442, which biases the buffer block 441 forwards; the buffer block 441 has a stopping slope 4411 corresponding to the right side of the gap 421; when the inverted U shaped locking member 3 is passed into the locking mechanism 4 through the trench shaped gap 411 of the bottom part 41 as well as the gap 421 of the housing member 42, it will be slowed down by the stopping slope 4411 of the buffer block 441 with the rear straight rod portion 31 coming into contact with the stopping slope 4411, and it will be finally stopped by the first buffer block 43;

a left pivotal shaft 45, the left pivotal shaft 45 is passed into the upper left pivotal hole 424 of the housing member 42 and the lower left pivotal hole 412 of the bottom plate part 41 at two ends thereof;

a locking piece 451 positioned around and pivoting on a lower end of the left pivotal shaft 45; the locking piece 451 has a pivotal hole 4512, through which the left pivotal shaft 45 is passed; the locking piece 451 has a connecting post 4511 thereon, a hooked locking portion 4513 in front of the pivotal hole 4512, and a detaining portion 4515 behind the pivotal hole 4512, which detaining portion 4515 has a detaining gap 4514;

a first torsion spring 452, the first torsion spring 452 is positioned around the left pivotal shaft 45, and hooked at one end thereof over the connecting post 4511 of the locking piece 451, and inserted at the other end thereof in the hollow confining portion 423 of the housing member 42 for biasing the locking piece 451 such that the locking piece 451 is normally in a non-locking position with the rear detaining portion 4515 thereof being in the gap 421, and the front hooked locking portion 4513 being away from the gap 421;

a right pivotal shaft 47, the right pivotal shaft 47 is passed into the upper right pivotal hole 426 of the housing member 42 and the lower right pivotal hole 413 of the bottom plate part 41 at two ends thereof;

a detaining piece 471, the detaining piece 471 is positioned around and pivoting on an upper end of the right pivotal shaft 47; the detaining piece 471 has a pivotal hole 4711, through which the right pivotal shaft 47 is passed; the detaining piece 471 has a detaining portion 4712 behind the pivotal hole 4711 at one end, and a handle portion 4713 at the other end thereof; the handle portion 4713 sticks outside from the right hollow containing portion 425 of the housing member 42;

a second torsion spring 472, the second torsion spring 472 is positioned around the right pivotal shaft 47, and passed at one end thereof through the detaining hole 414 of the bottom plate part 41, and hooked at the other end over an edge of the detaining piece 471 to bias the detaining piece 471 counterclockwise in order for allowing the detaining portion 4712 to engage the detaining portion 4515 of the locking piece 451; and

a second buffer block 46 positioned in a rear end of the hollow containing portion 425 for stopping the detaining piece 471 when the detaining piece 471 is biased counterclockwise by the second torsion spring 472.

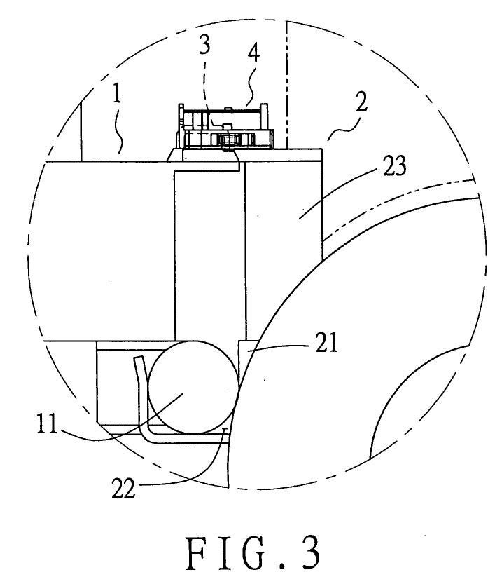

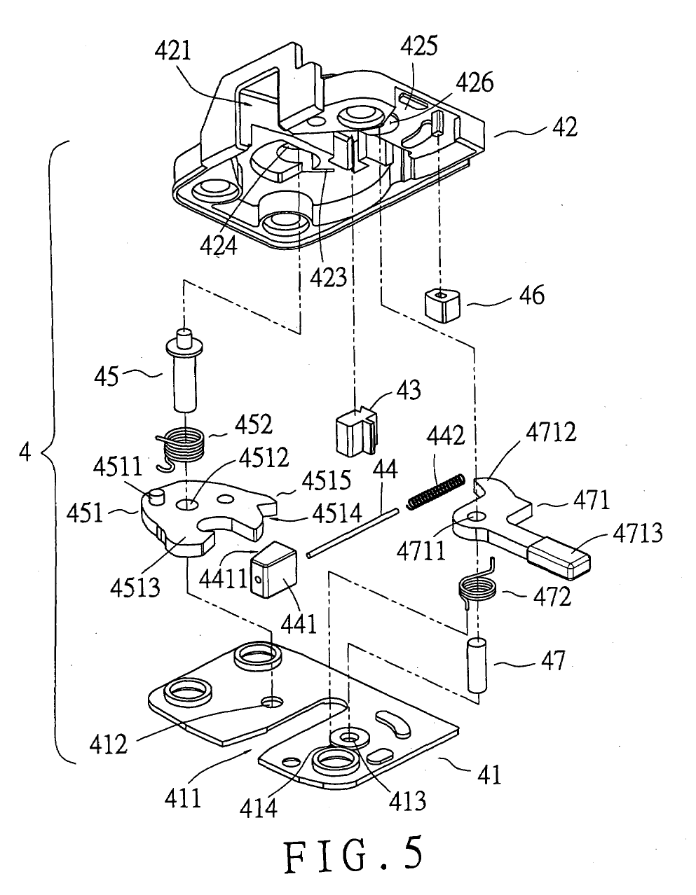

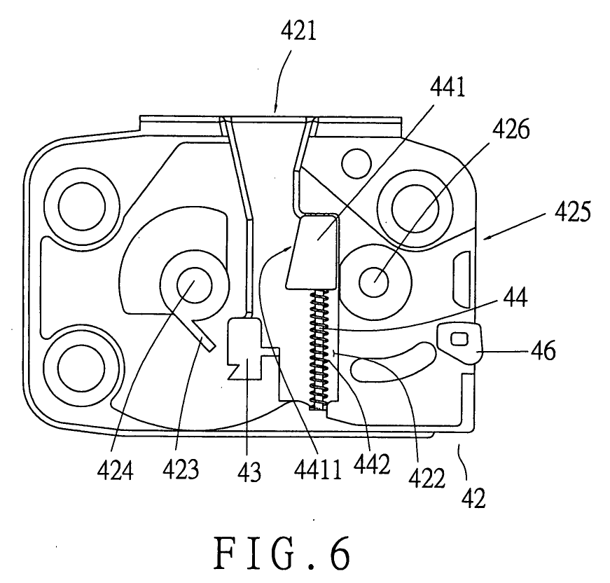

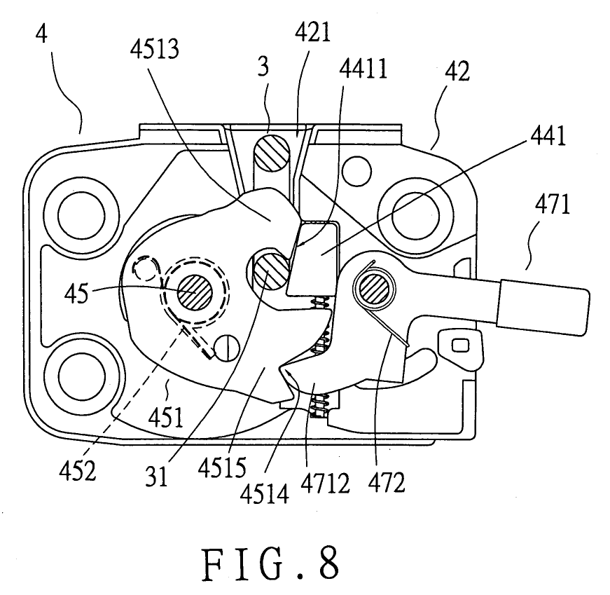

To assemble the chassis (join the front chassis 1 and the rear chassis 2 together), referring to FIGS. 2 and 3, first the rear transverse rod 11 of the front chassis 1 is passed into the locating portion 22 of the rear chassis 2, and the front chassis 1 and the rear chassis 2 are pivoted towards each other so as to pass the inverted U shaped locking member 3 into the locking mechanism 4 through the gap 421 of the housing member 42 as well as the trench shaped gap 411 of the bottom plate part 41; referring to FIGS. 5, 6 and 8 as well, when the inverted U shaped locking member 3 is being passed into the locking mechanism 4, the rear straight rod portion 31 will push the detaining portion 4515 of the locking piece 451 rearwards, and make the locking piece 451 pivot counterclockwise on the left pivotal shaft 45, and at the same time the hooked locking portion 4513 of the locking piece 451 will be moved to the front of and hooked over the rear straight rod portion 31 of the inverted U shaped locking member 3 to prevent the inverted U shaped locking member 3 from moving outwardly of the locking mechanism 4; immediately after, the rear straight rod portion 31 will continue moving rearwards, and will be slowed down by the stopping slope 4411 of the buffer block 441, and stopped by the first buffer block 43. As for the detaining piece 471, the detaining portion 4712 of the detaining piece 471 will be passed into the detaining gap 4514 of the detaining portion 4515 to engage the locking piece 451, and the second torsion spring 472 will bias the detaining piece 471 counterclockwise in order for the detaining piece 471 to prevent the locking piece 451 from being rotated clockwise by the first torsion spring 452; thus, the locking piece 451 is kept in the locking position to fix the inverted U shaped locking member 3 to the locking mechanism 4, and in turn the front chassis 1 and the rear chassis 2 are secured together.

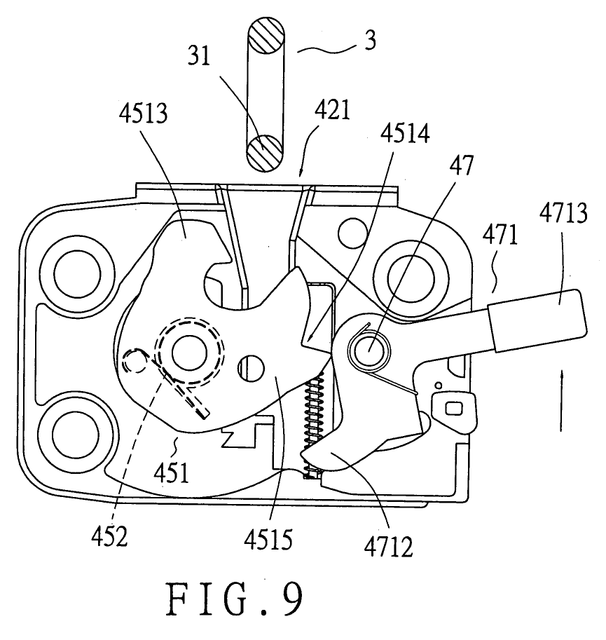

To separate the front chassis 1 from the rear chassis 2, referring to FIG. 9, first the user should exerts force on the handle portion 4713 of the detaining piece 471 to make the detaining piece 471 pivot clockwise on the right pivotal shaft 47; in the above-mentioned action, the detaining portion 4712 of the detaining piece 471 will be separated from the detaining gap 4514 of the detaining portion 4515 of the locking piece 451, and the first torsion spring 452 will make the locking piece 451 pivot clockwise. Consequently, the hooked locking portion 4513 of the detaining piece 451 is apart from the gap 421 of the housing member 42, and no longer hooked over the rear straight rod portion 31 of the inverted U shaped locking member 3, thus allowing the front chassis 1 to separate from the rear chassis 2.

From the above description, it can be seen that the present invention has an advantage: it is relatively easy, and takes little time and labor to assemble the people carrying vehicle chassis of the present invention because the front chassis only has to be pivoted close to the rear chassis in order for the front chassis and the rear chassis to be locked together after the rear transverse rod of the front chassis is passed into the locating hollow portion of the rear chassis.

What is claimed is:

1. An improvement on a chassis of a people carrying vehicle, comprising
(a) a front chassis, the front chassis having an inverted U shaped locking member on a rear end thereof;
(b) a rear chassis, and
(c) a locking mechanism fitted on the rear chassis for locking the inverted U shaped locking member so as to secure the front chassis and the rear chassis together; the locking mechanism including:
a bottom plate part, the bottom plate part having a trench shaped gap;
a housing member disposed over the bottom plate part, the housing member having a gap corresponding to the trench shaped gap of the bottom plate part; the housing member having a hollow containing portion on one side thereof;
a left pivotal shaft connected to both the bottom plate part and the housing member;
a right pivotal shaft connected to both the bottom plate part and the housing member;
a locking piece positioned around and pivoting on the left pivotal shaft, the locking piece being subjected to an elastic return force; the locking piece having a pivotal hole, through which the left pivotal shaft is passed; the locking piece having a hooked locking portion in front of the pivotal hole, and a detaining portion behind the pivotal hole thereof; the detaining portion having a detaining gap; said elastic return force biasing the locking piece towards a non-locking position, in which non-locking position the rear detaining portion of the locking piece will be in the gap, and the front hooked locking portion of the locking piece apart from the gap; and
a detaining piece positioned around and pivoting on the right pivotal shaft, the detaining piece being subjected to a second elastic return force; the detaining piece having a pivotal hole, through which the right pivotal shaft is passed; the detaining piece having a detaining end portion behind the pivotal hole thereof, and a handle portion at other end thereof; the handle portion sticking outside from the hollow containing portion of the housing member; said second elastic return force biasing the detaining piece in such a way as to allow the detaining piece to engage the detaining portion of the locking piece.

2. The improvement on a chassis of a people carrying vehicle as recited in claim 1, wherein the locking piece has a connecting post thereon, and the housing member has a hollow confining portion; a first torsion spring being positioned around the left pivotal shaft, and hooked at one end over the connecting post of the locking piece, and inserted at other end thereof in the hollow confining portion of the housing member for providing the locking piece with said elastic return force.

3. The improvement on a chassis of a people carrying vehicle as recited in claim 1, wherein the bottom plate part has a detaining hole thereon; a second torsion spring being positioned around the right pivotal shaft, and passed at one end thereof through the detaining hole of the bottom plate part, and hooked at other end thereof over an edge of the detaining piece for providing the detaining piece with said second elastic return force.

4. The improvement on a chassis of a people carrying vehicle as recited in claim 1, wherein a first buffer block is disposed next to one side of the gap in the housing member.

5. The improvement on a chassis of a people carrying vehicle as recited in claim 1, wherein the housing member has a hollow holding portion next to one side of the gap; a pivotal rod being received in the hollow holding portion of the housing member, and passed through a buffer block at a front end, and next passed through an elastic element; the buffer block having a stopping slope corresponding to said one side of the gap.

6. The improvement on a chassis of a people carrying vehicle as recited in claim 1, wherein a second buffer block is positioned in a rear end of the hollow containing portion of the housing member.
